(19) United States
(12) Patent Application Publication
(10) Pub. No.: US 2024/0361526 A1
(43) Pub. Date: Oct. 31, 2024

(54) Optical Connection Structure

(71) Applicant: Nippon Telegraph and Telephone Corporation, Tokyo (JP)

(72) Inventors: Takuma Aihara, Musashino-shi, Tokyo (JP); Shinji Matsuo, Musashino-shi, Tokyo (JP); Tatsuro Hiraki, Musashino-shi, Tokyo (JP); Yoshiho Maeda, Musashino-shi, Tokyo (JP)

(21) Appl. No.: 18/686,636

(22) PCT Filed: Sep. 29, 2021
(86) PCT No.: PCT/JP2021/035811

§ 371 Date: Feb. 26, 2024

(51) Int. Cl. G02B 6/122; G02B 6/12

(52) U.S. Cl. CPC G02B 6/1228; G02B 2006/12097

(57) ABSTRACT

An optical connection structure includes a first optical waveguide and a second optical waveguide. The first optical waveguide is a rib-type optical waveguide including a core and a slab by a rib. Also, the first optical waveguide is formed in an optical connection region on a substrate. The second optical waveguide is formed on the substrate. The second optical waveguide includes an Si core made of Si. The second optical waveguide is disposed on the substrate in the optical connection region to overlap the first optical waveguide in a height direction.

### TECHNICAL FIELD

The present invention relates to an optical connection structure.

### BACKGROUND ART

With the explosive increase in optical communication traffic, there is demand for high-speed, large-capacity, small-sized and low cost optical transceivers. In response to these requirements, attention has been paid to silicon photonics technology for forming an optical circuit on a large-diameter Si wafer by utilizing a mature CMOS manufacturing technology. Compact passive optical components using Si, high-speed optical modulator, and the like have heretofore been realized. Optical transceivers using these optical components have already been put into practical use.

On the other hand, Si is an indirect transition type semiconductor, and it is not easy to realize a highly efficient semiconductor laser and a semiconductor optical amplifier with Si. In the related art, a direct transition type semiconductor has been used as a material for optical components such as a semiconductor laser and a semiconductor optical amplifier. For this reason, an attempt has been made to epitaxially grow or directly join a compound semiconductor on an Si substrate, form a laser or an optical amplifier by the compound semiconductor, and monolithically integrate with an Si optical circuit, or individually form a laser on an InP substrate and hybrid integrate it with an Si optical circuit.

In the latter hybrid integrated circuit, there are a method of butt-connecting each chip (Si optical circuit and laser) and a method of transfer-printing the laser on the Si optical circuit (NPL 1).

In hybrid integration, although the assembly costs for integration are high, integration after sorting out good chips is enabled, and it is possible for individual optimal manufacturing processes to be applied in the Si and compound semiconductor device manufacturing. In particular, in the transfer printing, it is excellent that the above-mentioned advantages are ensured and the same integration as that of monolithic integration is achieved.

However, in the above-described technique, high-precision alignment is required to integrate the laser in an optically connected manner with a fine Si optical circuit. If the alignment accuracy is poor, the optical output from the laser cannot be input to the Si optical circuit. Typically, it is desired to perform the alignment with an accuracy of several 100 nm or less, but it is not easy in the current technology. For this reason, it is desired to realize an optical connection structure having a high tolerance against positional deviation. If there is an optical connection structure having a high tolerance to positional deviation, the laser and the Si optical circuit can be optically connected in a state (high efficiency) in which a large proportion of light is input to the Si optical circuit with respect to the output of the laser, even if there is a slight positional deviation.

### CITATION LIST

### Non Patent Literature

[NPL 1] R. KOU et al., “Inter-layer light transition in hybrid III-V/Si waveguides integrated by u-transfer printing”, Optics Express, vol. 28, No. 13, pp. 19772-19782, 2020.

### SUMMARY OF INVENTION

### Technical Problem

As described above, although transfer printing has been proposed as a method of integrating the laser in an Si optical circuit, if a positional deviation between the Si optical circuit and the laser occurs even to a small extent, there is a problem that light cannot be efficiently input (shining connection) to the Si optical circuit with respect to the output of the laser. In other words, the related art has a problem that the optical circuit and a semiconductor optical device such as a laser cannot be optically connected with high efficiency, unless the alignment is performed with high accuracy.

The present invention was made to solve the above-described problem, and an object thereof is to make it possible to optically connect an optical circuit and a semiconductor optical device with high efficiency, even if there is some positional deviation.

### Solution to Problem

An optical connection structure according to the present invention includes a first optical waveguide which is formed in an optical connection region on a substrate, and has a structure of a rib-type optical waveguide formed by a core and a slab due to a rib; and a second optical waveguide which is disposed on the substrate in the optical connection region to overlap the first optical waveguide in a height direction, and formed to extend to one end side of the first optical waveguide, in which the first optical waveguide and the second optical waveguide are optically connected in the optical connection region, and a value obtained by dividing a thickness of the rib of the first optical waveguide by a total thickness of the rib of the first optical waveguide and the slab of the first optical waveguide is less than 0.4.

### Advantageous Effects of Invention

As described above, according to the present invention, since the first optical waveguide disposed to overlap the second optical waveguide in the optical connection region on the substrate is formed as a rib-type optical waveguide structure formed by a core and a slab by a rib, the optical circuit and the semiconductor optical device can be optically connected with high efficiency even if there is some positional deviation.

### BRIEF DESCRIPTION OF DRAWINGS

FIG. 1 is a plan view showing a configuration of an optical connection structure according to an embodiment of the present invention.

FIG. 2A is a cross-sectional view showing a partial configuration of the optical connection structure according to the embodiment of the present invention.

FIG. 2B is a cross-sectional view showing a partial configuration of the optical connection structure according to the embodiment of the present invention.

FIG. 2C is a cross-sectional view showing a partial configuration of the optical connection structure according to the embodiment of the present invention.

FIG. 2D is a cross-sectional view showing a partial configuration of the optical connection structure according to the embodiment of the present invention.

FIG. 3A is a characteristic diagram showing a change in transmittance with respect to length in a waveguide direction of the first optical waveguide and the second optical waveguide when there is no positional deviation.

FIG. 3B is a characteristic diagram showing a change in transmittance with respect to length in a waveguide direction of the first optical waveguide and the second optical waveguide when there is a positional deviation.

FIG. 3C is a characteristic diagram showing a relationship between a height t_{rib} of a core 111 serving as a rib of a first optical waveguide 101 and a spread of a mode.

FIG. 3D is a characteristic diagram showing a relationship between a value [t_{rib}/(t_{rib}+t_{slab})], which is obtained by dividing the thickness trip of the core 111 by a total thickness (t_{rib}+t_{slab}) of the thickness t_{rib} of the core 111 and a thickness t_{slab} of the slab 112, and the transmittance.

FIG. 3E is a characteristic diagram showing a dependence (a) of an effective refractive index of the second optical waveguide 102 on the width of the Si core 121, and effective refractive indices and (c) of the (b) optical waveguide (semiconductor optical device 103) according to the active layer core 132.

FIG. 3F is a characteristic diagram showing dependency of transmission loss from the first optical waveguide 101 to the second optical waveguide 102 on the width of the Si core 121.

FIG. 3G is a characteristic diagram showing the dependence of the transmission loss from the first optical waveguide 101 to the second optical waveguide 102 on the width of the Si core 121, when a planar shape of the slab 112 at one end of the first optical waveguide 101 is inclined from a state perpendicular to the waveguide direction.

FIG. 4A is a plan view showing a configuration of another optical connection structure according to the embodiment of the present invention.

FIG. 4B is a cross-sectional view showing a partial configuration of another optical connection structure according to the embodiment of the present invention.

FIG. 5 is a plan view showing a configuration of another optical connection structure according to the embodiment of the present invention.

Fig. 6A is a cross-sectional view showing a partial configuration of still another optical connection structure according to the embodiment of the present invention.

FIG. 6B is a cross-sectional view showing a partial configuration of still another optical connection structure according to the embodiment of the present invention.

FIG. 6C is a cross-sectional view showing a partial configuration of still another optical connection structure according to the embodiment of the present invention.

FIG. 7A is a plan view showing a configuration of still another optical connection structure according to the embodiment of the present invention.

FIG. 7B is a cross-sectional view showing a partial configuration of still another optical connection structure according to the embodiment of the present invention.

FIG. 8 is a plan view showing a configuration of another optical connection structure according to the embodiment of the present invention.

FIG. 9 is a plan view showing a configuration of another optical connection structure according to the embodiment of the present invention.

FIG. 10A is a cross-sectional view showing a partial configuration of still another optical connection structure according to the embodiment of the present invention.

FIG. 10B is a cross-sectional view showing a partial configuration of still another optical connection structure according to the embodiment of the present invention.

### DESCRIPTION OF EMBODIMENTS

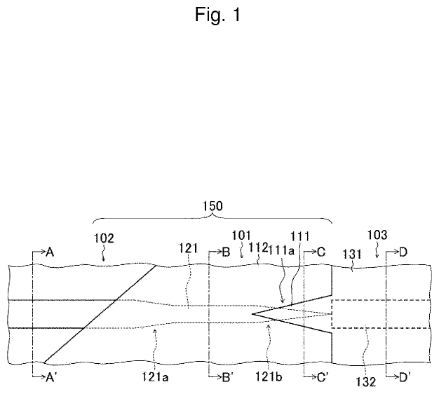

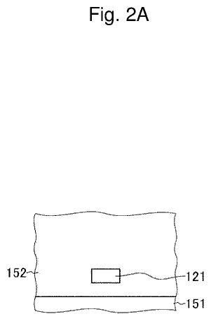

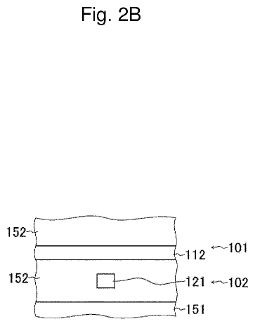

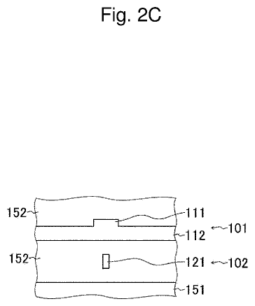

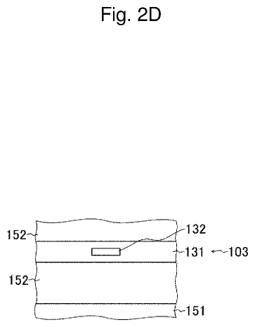

Hereinafter, an optical connection structure according to an embodiment of the present invention will be described with reference to FIGS. 1, 2A, 2B, 2C, and 2D. Also, FIG. 2A shows a cross-section taken along line AA′ of FIG. 1A, FIG. 2B shows a cross-section taken along line BB′ of FIG. 1A, FIG. 2C shows a cross-section taken along line CC′ of FIG. 1A, and FIG. 2D shows a cross-section along line DD′ of FIG. 1. The optical connection structure includes a first optical waveguide 101 and a second optical waveguide 102.

The first optical waveguide 101 is a rib-type optical waveguide including a core 111 and a slab 112 formed by a rib. Also, a first optical waveguide 101 is formed in an optical connection region 150 on a substrate 151.

The second optical waveguide 102 is formed on the main substrate 151. The second optical waveguide 102 includes an Si core 121 made of Si. The core 111, the slab 112, and the Si core 121 are embedded in a cladding layer 152 made of, for example, an insulating material. The second optical waveguide 102 is not limited to Si, and, for example, SiN, TiO₂, SiOₓ, or the like can be used as a core material. The second optical waveguide 102 is disposed on the substrate 151 to overlap the first optical waveguide 101 in a height direction in the optical connection region 150. The second optical waveguide 102 is formed to extend toward one end (left of paper surface of FIG. 1) side of the first optical waveguide 101.

In the optical connection region 150, the first optical waveguide 101 and the second optical waveguide 102 are optically connected. A value [t_{rib}/(t_{rib}+t_{slab})] obtained by dividing the thickness t_{rib} of the rib (core 111) of the first optical waveguide 101 by a total thickness (t_{rib}+t_{slab}) of the thickness t_{rib} of the rib (core 111) and the thickness t_{slab} of the slab 112 of the first optical waveguide 101 is less than 0.4.

In this example, the core 111 of the first optical waveguide 101 is formed into a tapered region 111a whose width in a plan view becomes narrower as it becomes closer to one end side of the first optical waveguide 101, and has an optical mode conversion structure. In addition, in this example, the Si core 121 of the second optical waveguide 102 includes a first tapered region 121a and a second tapered region 121b whose width in a plan view becomes narrower toward the other end (right of a paper surface in FIG. 1) side of the first optical waveguide 101.

In this example, an optical waveguide type semiconductor optical device 103 which is optically connected to the other end of the first optical waveguide 101 is provided. In the semiconductor optical device 103, an active layer core 132 serving as an active layer is embedded in a compound semiconductor layer 131 such as InP. On the substrate 151, the semiconductor optical device 103 is disposed at the same height as the first optical waveguide 101. As will be described later, the first optical waveguide 101 is an optical mode conversion mechanism provided in the optical connection region 150 to obtain an optical connection between the second optical waveguide 102 and the semiconductor optical device 103.

In this example, although the second optical waveguide 102 is disposed on the substrate 151 below the first optical waveguide 101 and the semiconductor optical device 103, the second optical waveguide 102 can be disposed above the first optical waveguide 101 and the semiconductor optical device 103, without being limited thereto.

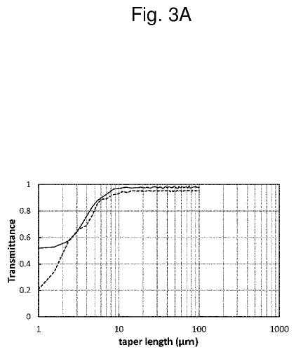

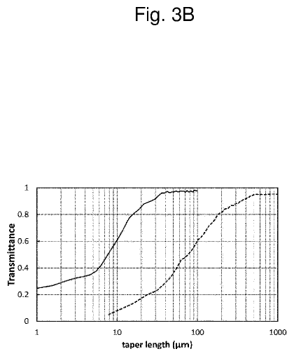

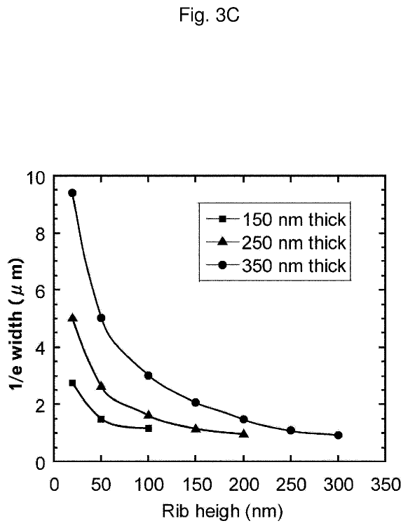

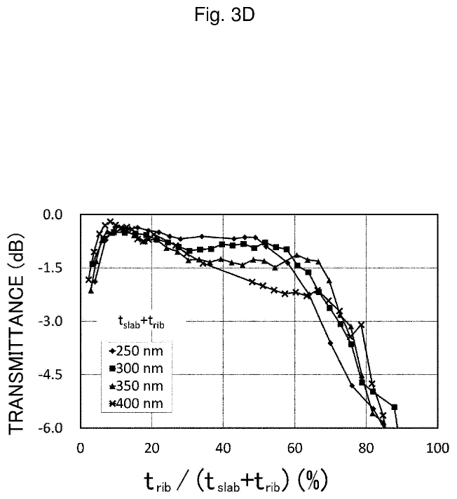

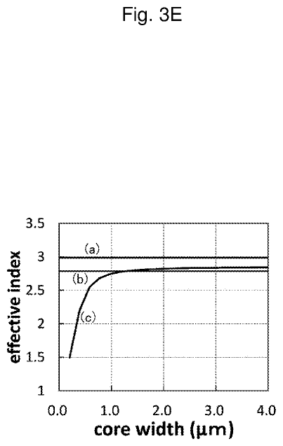

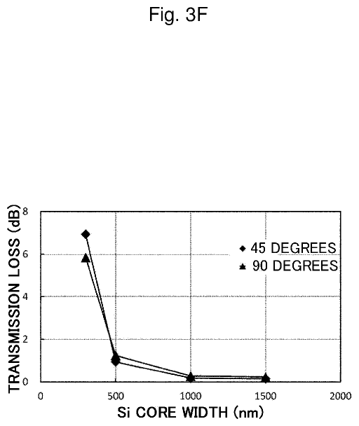

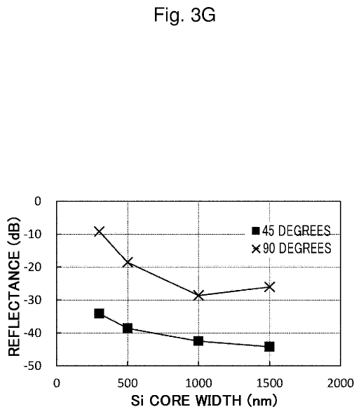

As described above, since the first optical waveguide 101 is a rib-type optical waveguide, the tolerance to the positional deviation from the Si core 121 in the optical connection region 150 is improved. FIG. 3A and FIG. 3B show changes in transmittance with respect to each amount of positional deviation with a horizontal axis being a length of the tapered region (first optical waveguide) and a vertical axis being the transmittance (optical coupling efficiency from the DD′ face to the BB′ face).

In FIGS. 3A and 3B, a solid line shows a case of using a rib-type optical waveguide, and a dotted line shows a case of not using a rib-type optical waveguide. FIG. 3A shows a case where there is no positional deviation, and FIG. 3B shows a case where a positional deviation of 500 nm occurs. The positional deviation represents a relative distance between the Si core 121 and the core 111 in the height direction (thickness of each layer) as viewed from the substrate 151.

As shown in FIG. 3A, when there is no positional deviation, the same transmittance can be obtained with the same length in the case of using the rib-type optical waveguide (solid line) and in the case of not using the rib-type optical waveguide (dotted line). On the other hand, as shown in FIG. 3B, when the positional deviation is 500 nm and when a rib-type optical waveguide is not used (dotted line), a length of about 1000 μm is required to obtain a high transmittance.

In contrast, it can be seen that by using the rib-type optical waveguide, a high transmittance at a length of about 1/10 is obtained as compared with the case where the rib-type optical waveguide is not used. In comparison with the same length, higher transmittance can be obtained by using a rib-type optical waveguide. This is because the first optical waveguide 101 in the optical connection region 150 is a rib-type optical waveguide, the spread of light in the horizontal direction when viewed in the cross section of the optical waveguide (waveguide direction) becomes large, and even if there is a positional deviation from the mode of the second optical waveguide 102 made of the Si core 121, the overlapping of the modes becomes relatively large.

The lower the height of the rib (core 111), the better. Especially when 0.4>t_{rib}/(t_{slab}+t_{rib}) is satisfied, the connection loss is significantly reduced. Now, the details thereof will be described.

FIG. 3C shows the height t_{rib} of the rib on the horizontal axis, and spread (1/e width) of mode in the horizontal direction on a vertical axis. Here, a thickness (thisc) of t_{slab}+t_{rib} is 150 nm (black square), 250 nm (black triangle), and 350 nm (black circle). The width of the rib (core 111) is assumed to be 100 nm as a practical minimum width which can be worked.

As shown in FIG. 3C, it can be seen that the spread of the mode in the horizontal direction becomes wider as the height of the rib (core 111) becomes smaller (thinner). In particular, when the alignment (position) deviation is 1 μm, the spread of 1 μm (2 μm on both sides) on one side is required as a standard. In order to satisfy this, for example, in the case of t_{slab}+t_{rib}=250 nm, it is necessary to make the thickness thin to satisfy t_{rib}<100 nm or less.

Specifically, the results obtained by using the horizontal axis as t_{rib}/(t_{slab}+t_{rib}) and the vertical axis as transmittance are shown in FIG. 3D. Here, the amount of positional deviation is assumed to be 1 μm. As shown in FIG. 3D, when the rib height (thickness of the core 111) increases to 0.5<t_{rib}/(t_{slab}+t_{rib}), the transmission loss increases significantly. On the other hand, if the ribs are formed thin so that the rib height satisfies 0.4>t_{rib}/(t_{slab}+t_{rib}), the transmission loss can be significantly suppressed (1.5 dB or less), even if the positional deviation is 1 μm.

Therefore, it is desirable that the height of the rib (core 111) be low to satisfy 0.4>t_{rib}/(t_{slab}+t_{rib}). In addition, since the amount of etching is small when the rib (core 111) is formed, there is an advantage that the processing is easy, and an error with respect to the amount of etching is also strong.

Further, the total thickness of the first optical waveguide 101 including the slab 112 and the core 111 made of the ribs is preferably 450 nm. The reason for this will be described. The first optical waveguide 101 is optically connected to an optical waveguide type semiconductor optical device 103 by the active layer core 132. If the thickness is different from that of the semiconductor optical device 103 (compound semiconductor layer 131), connection loss and reflection occur at a connection portion with the first optical waveguide 101. Therefore, it is desirable that these are of the same height (shallow). The optical waveguide type semiconductor optical device 103 formed by the active layer core 132 constitutes, for example, a semiconductor laser (described later).

As one of the forms of the semiconductor laser, a super mode optical waveguide can be formed by disposing the Si core 121 on the lower layer. By forming the super mode, light confinement in the active layer core 132 can be increased or decreased by the width of the Si core 121. For example, when the width of the Si core 121 is increased, the light confinement of the active layer core 132 is reduced. Thus, a semiconductor laser of high light output can be realized. As conditions for forming the super mode, the effective refractive indices of the respective optical waveguides need to match.

(a) of FIG. 3E shows the dependence of the effective refractive index of the second optical waveguide 102 on the width of the Si core 121. (b) and (c) of FIG. 3E show the effective refractive index of the optical waveguide (semiconductor optical device 103) formed by the active layer core 132. Here, the thickness of the optical waveguide according to the active layer core 132 is 200 nm (b) and 500 nm (c).

From this drawings, when the thickness of the optical waveguide type semiconductor optical device 103 (compound semiconductor layer 131) by the active layer core 132 is 200 nm, the effective refractive index of the second optical waveguide 102 and the semiconductor optical device 103 by the Si core 121 can be matched. On the other hand, if the thickness of the compound semiconductor layer 131 is 500 nm, the effective refractive index of the second optical waveguide 102 and the semiconductor optical device 103 cannot be matched. The thickness of the boundary between them is about 450 nm. Accordingly, the thickness of the semiconductor optical device 103 (compound semiconductor layer 131) is set to 450 nm or less, and in contrast, the thickness of the first optical waveguide 101 is set to 450 nm or less.

In the optical connection structure according to the above-described embodiment, the second optical waveguide 102 made of the Si core 121 extends on the side (side below) of the substrate 151 of the first optical waveguide 101. In a conventional Si optical circuit, since no slab exists on the upper layer, there is a need for connection (from the face BB′ to the face AA′ of FIG. 1) with an optical waveguide made of an Si core 121 in which no slab exists.

FIG. 1 is a diagram showing this connection structure. The Si core 121 has a structure in which the width becomes larger toward the other end side of the first optical waveguide 101 along an extending direction. On the side above the thickened Si core 121, the shape of the slab 112 at one end of the first optical waveguide 101 in a plan view is inclined from a state perpendicular to the waveguide direction. FIG. 3F shows the dependence of the transmission loss from the first optical waveguide 101 to the second optical waveguide 102 on the width of the Si core 121 in the optical connection structure according to the embodiment. Further, a case where the shape in a plane view at one end of the slab 112 is oblique (45 degrees) and a case where the shape is vertical (90 degrees) are shown, respectively.

As shown in FIG. 3F, it is known that the transmission loss can be suppressed by widening the width of the Si core 121. This is because, when the width of the Si core 121 is widened, the proportion of light confinement in the slab portion decreases, and mode discontinuity at the connection portion is reduced. Further, transmission loss can be suppressed by making the shape of one end of the slab 112 oblique. Further, as shown in FIG. 3G, by widening the width of the Si core 121 and making one end of the slab 112 oblique, the effect of suppressing reflection can be obtained.

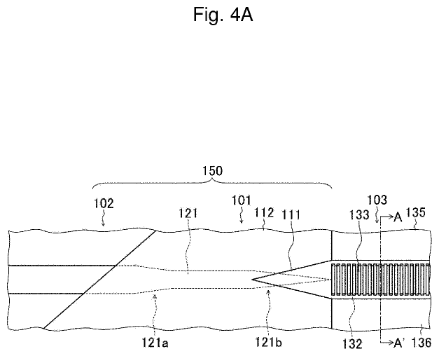

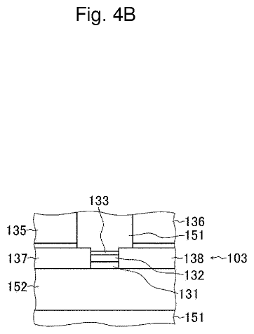

Although the connection structure with the two optical waveguides of the first optical waveguide 101 and the second optical waveguide 102 has been described above, the semiconductor optical device 103 having the optical waveguide structure constitutes a semiconductor laser. As shown in FIGS. 4A and 4B, a first semiconductor layer 137 and a second semiconductor layer 138 formed in a state of sandwiching the active layer core 132 in a direction perpendicular to the waveguide direction are provided in an optical waveguide (semiconductor optical device 103) by the active layer core 132. The first semiconductor layer 137 is made of, for example, a compound semiconductor doped with n-type impurities. In addition, the second semiconductor layer 138 is made of, for example, a compound semiconductor doped with p-type impurities. These are formed by doping the compound semiconductor layer 131 with corresponding impurities. The semiconductor optical device 103 includes a diffraction grating 133 formed on a layer on the active layer core 132. A first electrode 135 and a second electrode 136 are ohmic-connected to the first semiconductor layer the second semiconductor layer 138.

The semiconductor optical device 103 thus constructed is a semiconductor laser having the diffraction grating 133 as a distributed Bragg reflection structure. The semiconductor optical device 103 is not limited to a distributed feedback type laser using the diffraction grating 133, and may be an external resonator type laser using an external resonator provided in another optical waveguide connected to the semiconductor optical device 103.

Laser oscillation is obtained by injecting a current into the active layer core 132 of the semiconductor optical device 103 constituting the semiconductor laser via the first electrode 135 and the second electrode 136. The laser beam formed by the laser oscillation can be guided to the second optical waveguide 102 made of the Si core 121 by the optical connection structure according to the embodiment.

Here, the depth of the diffraction grating 133 is the same as the thickness of the core 111 by the rib. By making these states in the same state, the process of forming the diffraction grating 133 and the process of the core 111 can be performed collectively, and the manufacturing can be simplified. The depth of the diffraction grating 133 and the thickness of the core 111 may be differently configured. For example, the diffraction grating 133 has a relatively deep depth to obtain a high coupling coefficient. As a result, it is possible to obtain an effect of being able to form a laser with a short resonator length, low threshold voltage, and low power consumption.

Here, the total thickness of “In riv-core” and “In slab” in “hybrid III-V/Si optical waveguide” described in NPL 1 is about 750 nm, but in the embodiment, the thickness is as thin as 450 nm or less, and the effective refractive index of the second optical waveguide and the semiconductor optical device 103 by the Si core 121 can be matched.

In the “hybrid III-V/Si optical waveguide” described in NPL 1, “In riv-core” is thick (high) as 0.76=t_{rib}/(t_{slab}+t_{rib}). On the other hand, in the embodiment making the core 111 thin, the transmission loss is suppressed to 1.5 dB or less, even if there is a positional deviation of 1 μm.

In the “hybrid III-V/Si optical waveguide” described in NPL 1, the shape of the tab of “In slab” in a plan view is perpendicular to the waveguide direction, and the width of the Si core is narrow. On the other hand, in the embodiment, since the shape of the slab 112 at one end of the first optical waveguide 101 in a plan view is inclined from a state perpendicular to the waveguide direction, and the width of the Si core 121 at this point is increased, transmission loss and reflection can be suppressed.

In addition, in contrast to the technology of NPL 1, in the embodiment, since the core 111 is made thin and the first optical waveguide 101 and the semiconductor optical device 103 have the same thickness, the tapered shape provided in the core 111 is sufficient by one tapered region 111a.

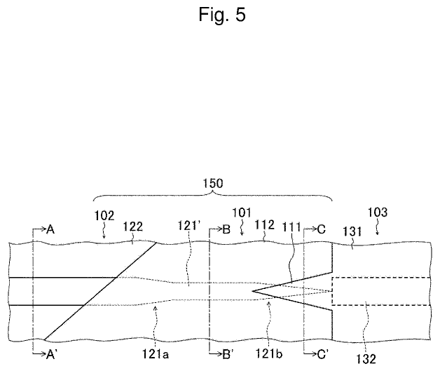

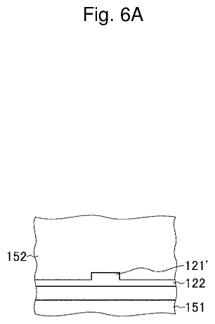

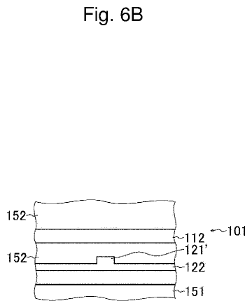

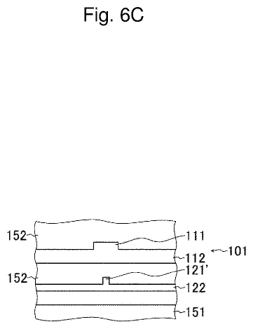

As shown in FIGS. 5, FIG. 6A, FIG. 6B and FIG. 6C, the second optical waveguide 102 can be a rib-type optical waveguide including a core 121 made of a rib and a slab 122. Also, FIG. 6A shows a cross-section taken along line AA′ of FIG. 5, FIG. 6B shows a cross-section taken along line BB′ of FIG. 5, and FIG. 6C shows a cross-section taken along line CC′ of FIG. 5. With this configuration, there is an effect in which the optical mode of the second optical waveguide 102 is also enlarged in the horizontal direction, and the tolerance to higher positional deviation is improved.

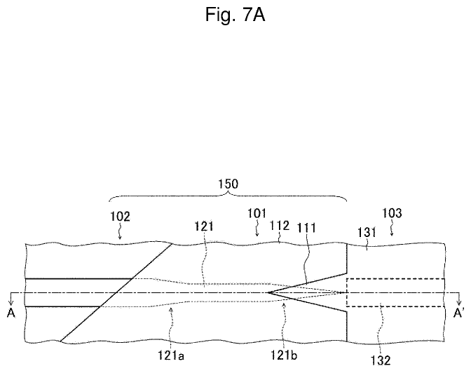

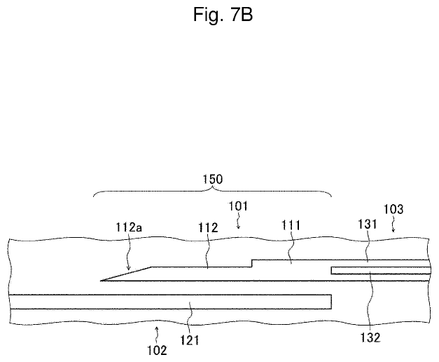

Further, as shown in FIGS. 7A and 7B, a tapered region 112a which becomes thinner toward one end side of the first optical waveguide 101 can be provided on a slab 112 of the first optical waveguide 101. Note that FIG. 7B shows a cross section of line AA′ of FIG. 7A. With this configuration, there is an effect in which coupling loss and reflection are further suppressed.

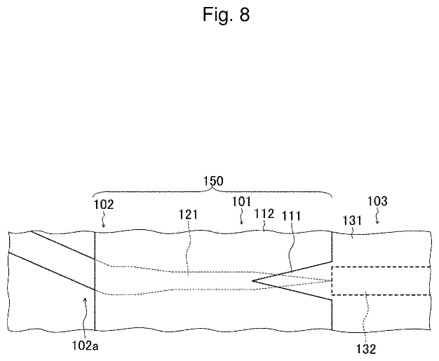

Further, as shown in FIG. 8, the shape in a plan view of the slab 112 of the first optical waveguide 101 at one end of the first optical waveguide 101 is perpendicular to the waveguide direction, and the waveguide direction of the second optical waveguide 102a at one end of the first optical waveguide 101 can be inclined with respect to the waveguide direction of the first optical waveguide 101 in a plan view. With this configuration, it is possible to obtain an effect equivalent to a configuration in which the shape of the slab 112 at one end of the first optical waveguide 101 in a plan view is inclined from a state perpendicular to the waveguide direction in a state in which the waveguide direction of the second optical waveguide 102 is the same as the waveguide direction of the first optical waveguide 101.

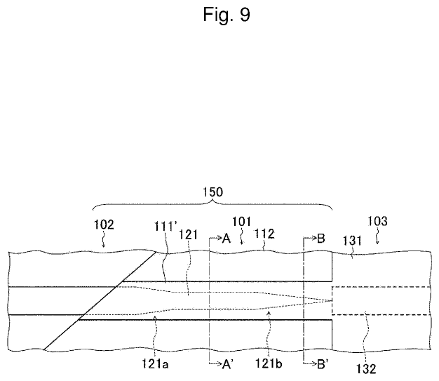

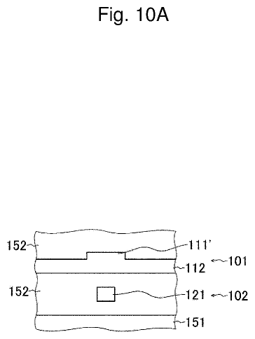

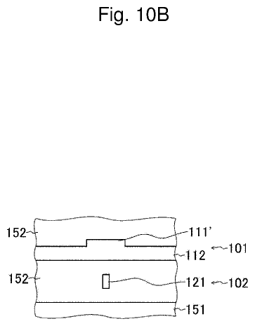

Further, as shown in FIGS. 9, 10A and 10B, a core 111′ having the same width in the waveguide direction can be constituted. FIG. 10A shows a cross-section taken along a line AA′ of FIG. 9, and FIG. 10B shows a cross-section taken along a line BB′ of FIG. 9. In this configuration, if the width of the Si core 121 is wide and most of the modes are confined in the Si core 121, the same effect as in the above-described embodiment can be obtained, and since a fine taper processing is not required, the manufacturing can be facilitated.

As described above, according to the present invention, since the first optical waveguide disposed to overlap the second optical waveguide in the optical connection region on the substrate is formed as a rib-type optical waveguide structure formed by the core and slab by the ribs, the optical circuit and the semiconductor optical device can be optically connected with high efficiency, even if there is some positional deviation.

Note that it is clear that the present invention is not limited to the embodiments described above and many modifications and combinations can be implemented by those skilled in the art within the technical concept of the present invention.

### Reference Signs List

101 First optical waveguide

102 Second optical waveguide

103 Semiconductor optical device

111 Core

111a Tapered region

112 Slab

121 Si core

121a First tapered region

121b Second tapered region

131 Compound semiconductor layer

132 Active layer core

1. An optical connection structure comprising:
a first optical waveguide which is formed in an optical connection region on a substrate, and has a structure of a rib-type optical waveguide formed by a core and a slab by a rib; and
a second optical waveguide which is disposed on the substrate in the optical connection region to overlap the first optical waveguide in a height direction, and formed to extend to one end side of the first optical waveguide,
wherein the first optical waveguide and the second optical waveguide are optically connected in the optical connection region, and
a value obtained by dividing a thickness of the rib of the first optical waveguide by a total thickness of the rib of the first optical waveguide and the slab of the first optical waveguide is less than 0.4.

2. The optical connection structure according to claim 1,
wherein the core of the second optical waveguide includes a tapered region whose width in a plan view becomes narrower toward the other end of the first optical waveguide.

3. The optical connection structure according to claim 1,
wherein the core of the first optical waveguide includes a tapered region whose width in a plan view becomes narrower toward one end side of the first optical waveguide.

4. The optical connection structure according to claim 1,
wherein a shape of the slab of the first optical waveguide at one end of the first optical waveguide in a plan view is inclined from a state perpendicular to a waveguide direction.

5. The optical connection structure according to claim 1,
wherein the shape of the slab of the first optical waveguide at one end of the first optical waveguide in a plan view is perpendicular to the waveguide direction, and
the waveguide direction of the second optical waveguide at one end of the first optical waveguide is inclined with respect to the waveguide direction of the first optical waveguide in a plan view.

6. The optical connection structure according to claim 1,
wherein the second optical waveguide is a rib-type optical waveguide including the core and the slab by the rib.

7. The optical connection structure according to claim 1,
wherein the slab of the first optical waveguide includes a tapered region that becomes thinner toward one end of the first optical waveguide.

8. The optical connection structure according to claim 1, comprising:
a waveguide type semiconductor optical device optically connected to the other end of the first optical waveguide.
